(19) United States
(12) Patent Application Publication
(10) Pub. No.: US 2016/0061614 A1
(43) Pub. Date: Mar. 3, 2016

(54) APPARATUS AND METHOD FOR ESTIMATING A POSITION OF A VEHICLE

(71) Applicant: HYUNDAI MOBIS CO., LTD., Seoul (KR)

(72) Inventors: Doo Yeon LEE, Yongin-si (KR); Jong In JUNG, Yongin-si (KR)

(21) Appl. No.: 14/823,250

(22) Filed: Aug. 11, 2015

(30) Foreign Application Priority Data
Sep. 2, 2014 (KR) 10-2014-0116237

(51) Int. Cl. G01C 21/30; G01S 19/07

(52) U.S. Cl. CPC G01C 21/30; G01S 19/07

(57) ABSTRACT

An apparatus for estimating a position of a vehicle comprises: a GPS receiving unit for receiving GPS signals from satellites; a V2I communicating unit in V2I based communication with a road-side base station; an inertial sensor unit for providing motion measurements including a speed and a direction of a vehicle; a database unit for storing an electronic map and a propagation map required to estimate the position of the vehicle; a propagation map generating unit for receiving the position estimated both from the motion measurements of the vehicle and the GPS signals and for generating the propagation map by combining V2I signals on the electronic map stored on the database unit; and a control unit for estimating the position of the vehicle using the propagation map based on the V2I signals received from the V2I communicating unit and compensating the position of the vehicle.

### CROSS-REFERENCES TO RELATED APPLICATIONS

The present application claims priority to Korean application number 10-2014-0116237, filed on Sep. 2, 2014, which is incorporated by reference in its entirety.

### BACKGROUND

1. Field

The present disclosure relates to an apparatus and method for estimating a position of a vehicle, and more particularly to an apparatus and method for estimating a position of a vehicle which can recognize a position of a vehicle using both a propagation map which is established based on a V2I (Vehicle to Infrastructure) wireless environment and an inertial navigation method, in a region where it is difficult to recognize a position of a vehicle using GPS (Global Positioning System) signals, when estimating a position of a vehicle.

2. Description of Related Art

A position of a mobile terminal in an outdoor area may be recognized in a high precision by using a GPS scheme of receiving GPS signals and calculating a current position of the mobile terminal from the GPS signals. However, as the GPS signals may not be received satisfactorily in a shaded area of the electromagnetic wave in an indoor or outdoor area, there is a disadvantage that a position of the mobile terminal may not precisely identified in the shaded area of the electromagnetic wave in the indoor or outdoor area.

Korean Patent Laid-open Publication No. 10-2012-0055906 published on Jun. 1, 2012 and entitled “POSITION RECOGNITION SYSTEM AND METHOD” discloses relevant information. The discussions in this section are for providing background information of the invention and do not constitute an admission of prior art.

### SUMMARY

One aspect of the invention provides a method of estimating a position of the vehicle during a journey. The method comprises: during the journey, continuously generating and storing, in a database, a propagation map of the vehicle using one or more of GPS signals, V2I signals and at least one motion measurement of the vehicle that are available; during the same journey, determining whether the position of the vehicle is properly estimated solely based on GPS signals; during the same journey, when determined that the position of the vehicle may not be estimated solely based on the GPS signals, determining whether V2I signals are available for use in estimating the position of the vehicle; during the same journey, when determined that the position of the vehicle may not be estimated solely based on the GPS signals and also determined that V2I signals are available, estimating the position of the vehicle based on the V2I signals and the propagation map stored in the database; and during the same journey, when determined that the position of the vehicle may not be estimated solely based on the GPS signals determined that V2I signals are not available, estimating the position of the vehicle based on at least one motion measurement of the vehicle and the propagation map stored in the database.

Embodiments of the present invention are directed to an apparatus and method for estimating a position of a vehicle, and more particularly to an apparatus and method for estimating a position of a vehicle which can recognize a position of a vehicle using both a propagation map which is established based on a V2I (Vehicle to Infrastructure) wireless environment and an inertial navigation method, in a region where it is difficult to recognize a position of a vehicle from GPS (Global Positioning System) signals, when estimating a position of a vehicle.

Other embodiments of the present invention is directed to an apparatus and method for estimating a position of a vehicle, and more particularly to an apparatus and method for estimating a position of a vehicle which can recognize a position of a vehicle using a propagation map established by storing on an electronic map attribute values of a V2I (Vehicle to Infrastructure) wireless environment using both GPS (Global Positioning System) signals and an inertial navigation method, when estimating a position of a vehicle.

An apparatus for estimating a position of a vehicle according to an embodiment of the present invention may include a GPS receiving unit for receiving GPS signals from satellites; a V2I communicating unit in V2I based communication with a road-side base station; an inertial sensor unit for providing motion measurements including a speed and a direction of a vehicle; a database unit for storing an electronic map and a propagation map required to estimate the position of the vehicle; a propagation map generating unit for receiving the position estimated both from the motion measurements of the vehicle and the GPS signals and for generating the propagation map by combining V2I signals on the electronic map stored on the database unit; and a control unit for estimating the position of the vehicle using the propagation map based on the V2I signals received from the V2I communicating unit according to whether it is possible to estimate the position of the vehicle from the GPS signals received from the GPS receiving unit; compensating the position of the vehicle by the position of the vehicle estimated from the motion measurements of the vehicles received from the inertial sensor unit according to an intensity of the V2I signals and the GPS signals; and storing to a database unit the propagation map generated by providing the V2I signals and the position estimated both from the motion measurements of the vehicle and the GPS signals to the propagation map generating unit.

According to another embodiment, the V2I signals may include an ID of a road-side base station, a position of the road-side base station, a current time and signal strength.

According to another embodiment, the motion measurements of the vehicle may include a speed, acceleration and a steering angle of the vehicle.

According to another embodiment, the road-side base station may be at least one of base stations for DSRC (Dedicated Short Range Communication), UTIS (Urban Traffic Information System), WAVE (Wireless Access in Vehicular Environments), WLAN-Wibro (Wireless LAN-Wireless Broadband Internet), W-CDMA (Wide band Code Division Multiple Access), LTE (Long Term Evolution), or CDMA (Code Division Multiple Access) communication.

A method for estimating a position of a vehicle according to another embodiment of the present invention may include deciding, by a control unit, whether it is possible to receive GPS signals from a GPS receiving unit and to estimate the position of the vehicle from the GPS signals; estimating, by the control unit, the position of the vehicle from the GPS signals according to whether it is possible to estimate the position of the vehicle from the GPS signals, or deciding whether it is possible to estimate the position of the vehicle from V2I signals received from a V2I communicating unit in V2I based communication with a road-side base station; and estimating, by the control unit, the position of the vehicle based on both a propagation map stored on a database unit and the V2I signals according to whether it is possible to estimate the position of the vehicle from the V2I signals, or estimating the position of the vehicle from the motion measurements of the vehicles received from an inertial sensor unit.

According to another embodiment, when the control unit estimates the position of the vehicle from the GPS signals, if a precision of the GPS signals is above a preset precision, the control unit may estimate the position of the vehicle by compensating the position estimated from the motion measurements of the vehicle received from the inertial sensor unit for the position estimated from the GPS signals.

According to another embodiment, when the control unit estimates the position of the vehicle from the V2I signals, if it is decided that the V2I signals are not satisfactorily received, the control unit may estimate the position of the vehicle by compensating the position estimated from the motion measurements received from the inertial sensor unit for the position estimated from the V2I signals.

According to another embodiment, whether the V2I signals are satisfactorily received may be decided by a matching rate and signal strength of the V2I signals.

According to another embodiment, the V2I signals may include an ID of a road-side base station, a position of the road-side base station, a current time and signal strength.

According to another embodiment, the motion measurements of the vehicle may include a speed, acceleration and a steering angle of the vehicle.

A method for estimating a position of a vehicle according to another embodiment of the present invention may include deciding, by a control unit, whether it is possible to receive GPS signals from a GPS receiving unit and to estimate the position of a vehicle from the GPS signals: estimating, by the control unit, the position of the vehicle from the GPS signals according to whether it is possible to estimate the position from the GPS signals, or estimating the position from the motion measurements of the vehicle received from an inertial sensor unit; and generating, by the control unit, a propagation map by combining V2I signals received from a V2I communicating unit in V2I based communication with a road-side base station on an electronic map stored on a database unit corresponding to the estimated position.

According to another embodiment, the V2I signals may include an ID of a road-side base station, a position of the road-side base station, a current time and signal strength.

According to another embodiment, the motion measurements of the vehicle may include a speed, acceleration and a steering angle of the vehicle.

An apparatus and method for estimating a position of a vehicle according to an embodiment of the present invention can recognize a position of a vehicle using both a propagation map which is established based on a V2I (Vehicle to Infrastructure) wireless environment and an inertial navigation method, in a region where it is difficult to estimate a position of a vehicle using GPS (Global Positioning System) signals, when estimating a position of a vehicle, thus improving service qualities due to estimating more precisely and efficiently a position of a vehicle in a region where it is difficult to recognize a position of a vehicle in a position based service.

Also, the apparatus and method according to an embodiment of the present invention can estimate more precisely and efficiently a position of a vehicle, in a shaded region where it is difficult to recognize a position of a vehicle in a position based service, by utilizing as data for estimating a position of a vehicle, a propagation map established by storing on an electronic map attribute values of a V2I (Vehicle to Infrastructure) wireless environment using both GPS (Global Positioning System) signals and an inertial navigation method, when estimating a position of a vehicle.

### BRIEF DESCRIPTION OF THE DRAWINGS

FIG. 1 is a block diagram for illustrating an apparatus for estimating a position of a vehicle according to an embodiment of the present invention.

FIG. 2 is a diagram for illustrating a use environment of the apparatus for estimating a position of a vehicle according to an embodiment of the present invention.

FIG. 3 is a flow chart for illustrating a method for estimating a position of a vehicle according to an embodiment of the present invention.

FIG. 4 is a flow chart for illustrating a procedure for generating a propagation map in the method for estimating a position of a vehicle according to an embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only.

To address the precision issue in position recognition, either a cell based scheme or a Wi-Fi based scheme has been used, or a scheme in which a near field wireless module, e.g., Bluetooth, UWB (Ultra WideBand) or RFID (Radio Frequency IDentification) and an inertial navigation method are combined has been used.

By the way, as the cell based scheme or the Wi-Fi based scheme is very low in a precision, a position recognized based on the scheme may be in a large error in the order of hundreds of meters to thousands of meters. On the other hand, the scheme in which the near field wireless module and the inertial navigation method are combined may recognize an initial position using the near field wireless module and continue to recognize subsequent positions from the initial position by applying the inertial navigation method, but the near field wireless network (Bluetooth, UWB or RFID network) needs to be installed. Thus there is the disadvantage that to apply the combination method for a large area results in the increase of cost.

Also, recently it is a trend to introduce a traffic information system based on a Dedicated Short Range Communication (DSRC) to provide an intelligent transportation system service, wherein the traffic information system based on the dedicated short range communication can provides the services such as retrieving the road-side circumstances via base stations positioned at the sides of the road, collecting and providing traffic information, and delivering the traffic signals.

Accordingly, the traffic information system based on the dedicated short range communication has been established in the national freeway and the district roads nationwide, and can provide traffic information such as a traffic volume and a density which are provided fundamentally, to the on-board equipment via communications between vehicles (Vehicle to Everything or Vehicle to X, which is referred to as ‘V2X’ in the following), so that the traffic information provided can be utilized variously.

Here, the term X in the V2X refers to everything, i.e., Infra/Vehicle/Nomadic/ . . . and the like, and the V2X represents all the type of communication schemes which can be possibly applied to the vehicle, or means specific communications techniques for implementing a general term ‘Connected Vehicle’ or ‘Networked Vehicle’.

And, V2X communication can largely classified into three categories: communication between a vehicle and an infrastructure (Vehicle-to-Infrastructure: V2I), communication between a vehicle and a vehicle (Vehicle-to-Vehicle: V2V), and communication between a vehicle and a mobile device (Vehicle-to-Nomadic device: V2N), and recently it is expected that other types of communication categories can be added.

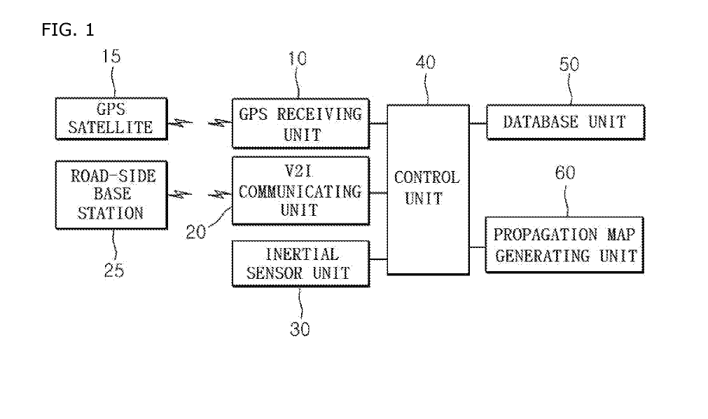

FIG. 1 is a block diagram for illustrating an apparatus for estimating a position of a vehicle according to an embodiment of the present invention.

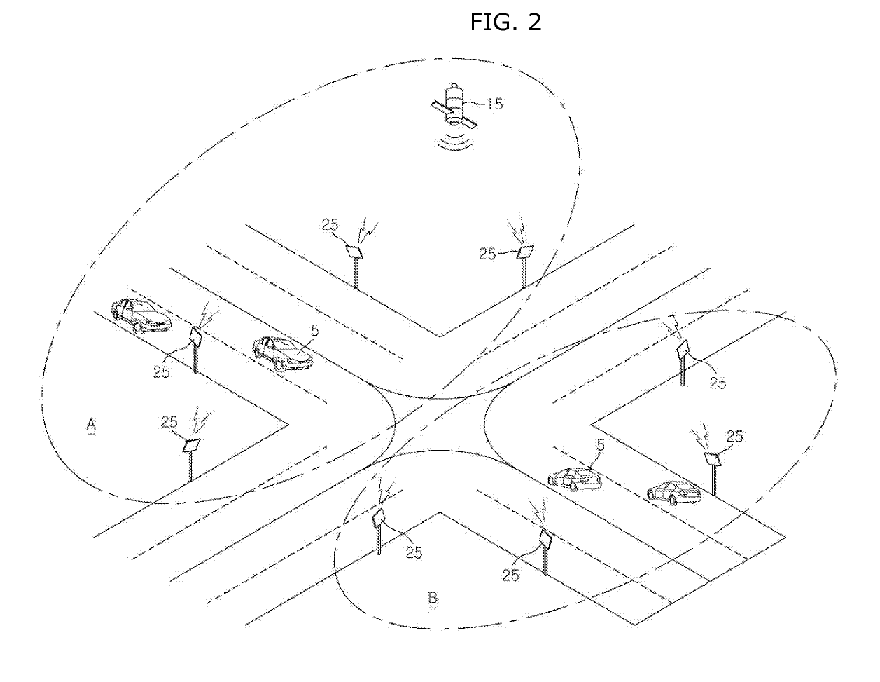

FIG. 2 is a diagram for illustrating an environment for the use of the apparatus for estimating a position of a vehicle according to an embodiment of the present invention.

As shown in FIGS. 1 and 2, an apparatus for estimating a position of a vehicle according to an embodiment of the present invention may comprise a GPS receiving unit 10, a V2I communicating unit 20, an inertial sensor unit 30, a database unit 50, a propagation map generating unit 60 and a control unit 40.

The GPS receiving unit 10 may receive GPS signals from GPS satellites 15 and provide signals modified in a form from which it is possible to estimate a position of a vehicle. Here, the GPS signals may comprise pseudo distances from the satellites, position information of the satellites and current time.

The V2I communicating unit 20 can perform V2I based communication with road-side base stations 25 which are established at the sides of a road via at least one of DSRC (Dedicated Short Range Communication), UTIS (Urban Traffic Information System), WAVE (Wireless Access in Vehicular Environments), WLAN-Wibro (Wireless LAN-Wireless Broadband Internet), W-CDMA (Wide band Code Division Multiple Access), LTE (Long Term Evolution), and CDMA (Code Division Multiple Access) to provide safety, convenience and Internet service. Here, V2I signals may comprise a ID of a road-side base station, a position of the road-side base station, current time and signal strength so that it is possible to estimate a position of a vehicle from the V2I signals.

This road-side base station 25 may broadcast periodically a network attribute data including setting values including a transfer speed, a channel, application service, etc., that the road-side base station 25 can provide, via which the V2I communicating unit (200) of a vehicle can try to access the road-side base station.

The inertial sensor unit 30 may include one or more sensors such as a speed sensor and/or a steering angle sensor. Using the one or more sensors, the inertial sensor unit 30 may provide one or more motion measurements of the vehicle such as a speed, an acceleration and a steering angle of a vehicle.

Thus, subsequent positions will be estimated from previous positions based on the motion measurements including the speed, time, the acceleration and the steering angle of the vehicle provided by the inertial sensor unit 30.

The database unit 50 may store an electronic map and a propagation map required to estimate a position of the vehicle 5.

The propagation map generating unit 60 may receive the position estimated from the motion measurements of the vehicle 5 and the GPS signals and generate the propagation map by combining the V2I signals on the electronic map stored in the database unit 50.

In other words, the propagation map may be generated by combining the V2I signals received from the V2I communicating unit 20 on a coordinate corresponding to the position estimated from the electronic map.

For example, roads are represented by Link IDs which range several tens of meters to several hundreds of meters. Assuming that Link IDs are assigned to a road by a grid and each ID is referred to as Link ID_P1˜P100, the road-side base station IDs and the signal strengths of the V2I signals received at the position corresponding to each Link ID_P1 may be stored. In this case, there may be multiple V2I signals of the road-side base station 25 received in its position.

The control unit 40 may estimate a position of a vehicle using the propagation map from the V2I signals received from the V2I communicating unit 20 according to whether it is possible to estimate a position of a vehicle from the GPS signals received from the GPS receiving unit 10.

In other words, the control unit 40 may estimate a position of a vehicle from the GPS signals in a ‘A’ region in FIG. 2 where it is possible to estimate a position from the GPS signals received from the GPS receiving unit 10, and estimate a position of a vehicle using the propagation map from the V2I signals received from the V2I communicating unit 20 in a place where it is impossible to estimate a position from the GPS signals as in the ‘B’ region.

In this case, the control unit may estimate a position of a vehicle using an area grouping method for grouping areas with similar propagating environment in a group and estimating a position from the areas in the group, without comparing the propagation map with received V2I signals one by one, when estimating a position using the propagation map.

Also, when estimating a position from the GPS signals, if a precision of the GPS signals exceeds a preset precision, the control unit 40 may estimate a position of a vehicle from the GPS signals, but if a precision of the GPS signals is below or equal to a preset precision, the control unit 40 may estimate a position of a vehicle by compensating a position estimated from the motion measurements of the vehicle 5 received from the inertial sensor unit 30 for the position estimated from the GPS signals.

And, the control unit 40 may estimate a position of a vehicle using the propagation map from the V2I signals, if it is decided that the V2I signals are satisfactorily received, when estimating a position from the V2I signals received from the V2I communicating unit 20, but the control unit may estimate a position of a vehicle by compensating a position estimated from the motion measurements of the vehicle 5 received from the inertial sensor unit 30 for the position estimated using the propagation map from the V2I signals if the V2I signals are not satisfactorily received.

In this case, when the control unit decides whether the V2I signals are satisfactorily received, the control unit may decide whether the V2I signals are satisfactorily received, based on the signal strength and matching rate of the V2I signals. The matching rate means that the V2I signals are received from three or more road-side base stations 25 from which it is possible to estimate a position by the trigonometry, and the control unit may decide that the V2I signals having 70% or more of the matching rate is satisfactorily received, assuming the optimal matching rate is represented by 100%.

On the other hand, the control unit 40 may estimate a position of a vehicle from the motion measurements of the vehicle 5 received from the inertial sensor unit 30 when it is not possible to estimate a position either from the V2I signals or the GPS signals.

Also, the control unit 40 may store to the database unit 50 the propagation map generated by providing the position estimated from both the motion measurements of the vehicle 5 and the GPS signals and the V2I signals to the propagation map generating unit.

In other words, the control unit 40 may receive the GPS signals from the GPS receiving unit 10 and estimate a position of a vehicle from the GPS signals when it is possible to estimate a position of a vehicle from the GPS signals, so that it is possible to generate the propagation map by combining the V2I signals on the electronic map of the estimated position.

On the other hand, when it is impossible to estimate a position of a vehicle from the GPS signals, the control unit may generate the propagation map by combining the V2I signals on the electronic map corresponding to the positions estimated from the motion measurements of the vehicle 5 received from the inertial sensor unit 30.

As mentioned above, the apparatus for estimating a position of a vehicle according to an embodiment of the present invention can estimate a position of a vehicle using both the propagation map established based on a V2I (Vehicle to Infrastructure) wireless environment and the inertial navigation method, in a region where it is difficult to recognize the position of a vehicle from the GPS (Global Positioning System) signals, thus improving service qualities due to estimating more precisely and efficiently the position of a vehicle, even in a region where it is different to recognize the position of the vehicle from the position based service.

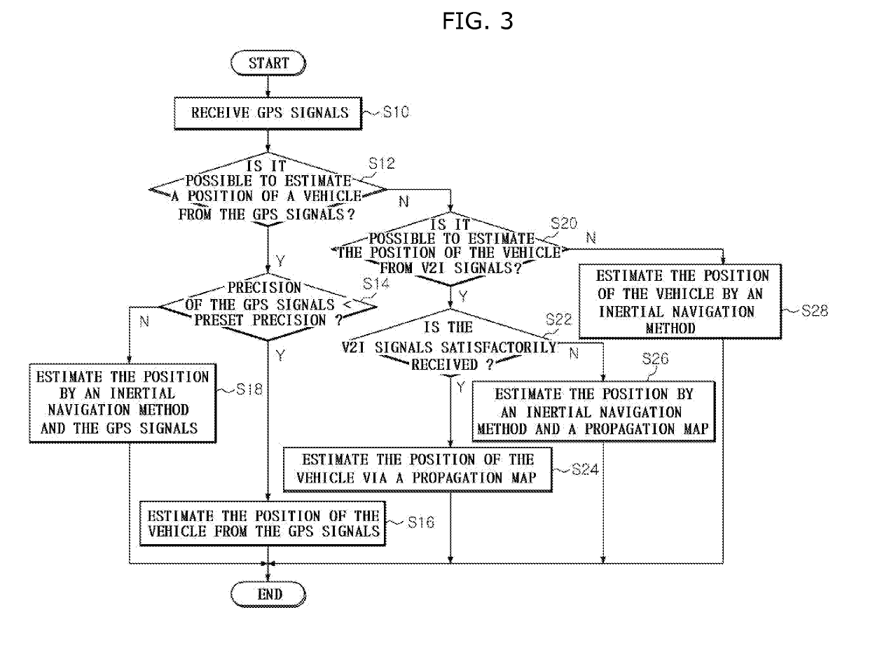

FIG. 3 is a flow chart for illustrating a method for estimating a position of a vehicle according to an embodiment of the present invention.

As shown in FIG. 3, a method for estimating a position of a vehicle according to an embodiment of the present invention may comprise, first of all, receiving, by the control unit 40, GPS signals from the GPS receiving unit 10 (S10). And then, the control unit 40 may decide whether it is possible to estimate a position of a vehicle from the GPS signals (S12).

In other words, when it is impossible to receive the GPS signals, the control unit may decide that it is impossible to estimate the position of the vehicle from the GPS signals.

In step S12, when it is possible to estimate a position of a vehicle from the GPS signals, the control unit 40 may compare a precision of the GPS signals with a preset precision (S14).

The precision of the GPS signals is provided in a meter unit, and thus assuming that the preset precision is set to 5 m, when the precision of the GPS signals is below 5 m, the control unit may estimate a position of a vehicle from the GPS signals (S16).

By the way, in step S14, when the precision of the GPS signals is above the preset precision, e.g., when the precision of the GPS signals is above 5 m, the control unit 40 may estimate a position of a vehicle by compensating the position estimated by the inertial navigation method from the motion measurements of the vehicle 5 received from the inertial sensor unit 30 for the position estimated from the GPS signals (S18).

In other words, the control unit may estimate a position of a vehicle by compensating the position estimated from the GPS signals by estimating a subsequent position from the previous position based on the motion measurements of the vehicle 5 including the speed, time, acceleration and steering angle of the vehicle 5 measured by the inertial navigation method.

On the other hand, in step S12, when it is impossible to estimate the position of the vehicle from GPS signals, the control unit 40 may decide whether it is possible to estimate the position of the vehicle from the V2I signals received from the V2I communicating unit 20 in V2I based communication with the road-side base stations 25 (S20).

In this case, whether it is possible to estimate the position of the vehicle from the V2I signals may be decided according to whether there is a matching in the V2I signals and the reception strength.

In other words, the V2I signals may include an ID of a road-side base station, a position of the road-side base station, current time and signal strength, and thus when the reception strength is below the preset strength, or when the V2I signals is not received from three or more road-side base stations 25 to estimate the position, there is no matching, thus it is impossible to estimate the position of the vehicle.

In step S20, when it is impossible to estimate the position from the V2I signals, the control unit 40 may estimate the position of the vehicle by the inertial navigation method based on the motion measurements of the vehicle 5 received from the inertial sensor unit 30 (S28).

However, in step S20, when it is possible to estimate the position of the vehicle from the V2I signals, the control unit 40 may decide whether the V2I signals are satisfactorily received (S22).

Here, whether the V2I signals are satisfactorily received may be decided according to the signal strength of the V2I signals and matching rate. The matching rate means that the V2I signals are received from three or more road-side base stations 25 from which it is possible to estimate a position by the trigonometry, and the control unit may decide that the V2I signals having 70% or more of the matching rate is satisfactorily received assuming that the optimal matching rate is represented by 100%.

Accordingly, in step S22, when the V2I signals are satisfactorily received, the control unit 40 may estimate the position of the vehicle from both the propagation map stored on the database unit 50 and the V2I signals (S24).

However, in step S22, when the V2I signals are not satisfactorily received, the control unit 40 may estimate the position of the vehicle by compensating the position estimated by the inertial navigation method based on the motion measurements of the vehicle 5 received from the inertial sensor unit 30 for the position estimated both from the propagation map stored on the database unit 50 and the V2I signals (S26).

As mentioned above, the method for estimating the position of the vehicle according to an embodiment of the present invention can estimate the position of the vehicle using both the propagation map established based on the V2I (Vehicle to Infrastructure) wireless environment and the inertial navigation method, in a region where it is difficult to recognize the position of the vehicle using the GPS (Global Positioning System) signals, thus improving service qualities due to estimating more precisely and efficiently the position of the vehicle in a region where it is difficult to recognize the position in the position based service.

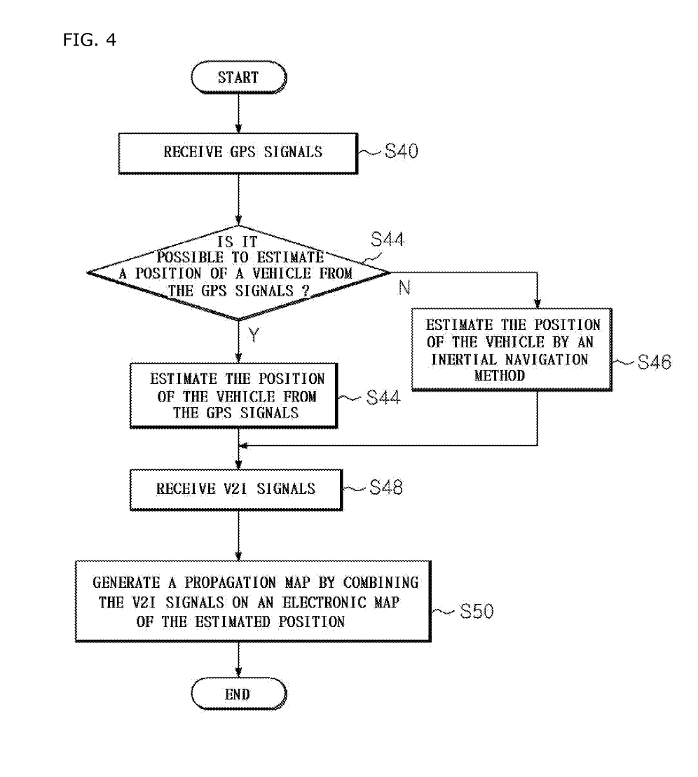

FIG. 4 is a flow chart for illustrating a procedure for generating a propagation map in the method for estimating a position of a vehicle according to an embodiment of the present invention.

As shown in FIG. 4, in the method for estimating the position of the vehicle according to an embodiment of the present invention a procedure of generating the propagation map may comprise firstly receiving, by the control unit 40, the GPS signals from the GPS receiving unit 10 (S40). And then, the control unit 40 may decide whether it is possible to estimate the position of the vehicle from the GPS signals (S42).

In other words, when it is not possible to receive the GPS signals, the control unit may decide that it is impossible to estimate the position of the vehicle from the GPS signals.

In step S42, when it is possible to estimate the position of the vehicle from the GPS signals, the control unit 40 may decide the position of the vehicle from the GPS signals (S44).

Then, the control unit 40 may receive the V2I signals from the V2I communicating unit 20 (S48).

And then, the control unit 40 may generate the propagation map by combining the V2I signals received from the V2I communicating unit 20 in V2I based communication with the road-side base station 25 on the electronic map stored on the database unit 50 corresponding to the position estimated from the GPS signals (S50). In other words, the control unit may generate the propagation map by storing the IDs and the signal strengths of the road-side base stations from the received V2I signals on the electronic map corresponding to the Link ID.

On the other hand, in step S42, when it is impossible to estimate the position from the GPS signals, the control unit 40 may estimate the position of the vehicle 5 from the position estimated from the recent GPS signals based on the motion measurements including the speed, time, acceleration and steering angle of the vehicle 5 received from the inertial sensor unit 30 (S46).

And then, the control unit 40 may receive the V2I signals from the V2I communicating unit 20 (S48), and generate the propagation map by combining the V2I signals received from the V2I communicating unit 20 in V2I communication with the road-side base station 25 on the electronic map stored on the database unit 50 based on the position estimated by the inertial navigation method (S50).

As mentioned above, the method for estimating the position of the vehicle according to an embodiment of the present invention can estimate more precisely and efficiently the position of the vehicle in a region where it is difficult to estimate the position of the vehicle from the position based service, by utilizing as data for estimating a position of a vehicle, the propagation map established by storing on the electronic map the attribute values of the V2I (Vehicle to Infrastructure) wireless environment using both the GPS (Global Positioning System) signals and the inertial navigation method, when estimating the position of the vehicle.

While the present invention have been described with reference to embodiments shown in the drawings, the present invention is not limited to the specific embodiments described herein. It will be thus appreciated by the skilled person in the art that various variants or modifications may be made without departing from the scope and spirit of the invention. Therefore, the scope of the present invention should be defined only in accordance with the following claims and their equivalents.

What is claimed is:

1. An apparatus for estimating a position of a vehicle, comprising:
a GPS receiving unit for receiving GPS signals from satellites;
a V2I communicating unit in V2I based communication with a road-side base station;
an inertial sensor unit for providing motion measurements including a speed and a direction of the vehicle;
a database unit for storing an electronic map and a propagation map required to estimate the position of the vehicle;
a propagation map generating unit for receiving the position estimated both from the motion measurements of the vehicle and the GPS signals and for generating the propagation map by combining V2I signals on the electronic map stored on the database unit; and
a control unit for estimating the position of the vehicle using the propagation map based on the V2I signals received from the V2I communicating unit according to whether it is possible to estimate the position of the vehicle from the GPS signals received from the GPS receiving unit; compensating the position of the vehicle by the position of the vehicle estimated from the motion measurements of the vehicles received from the inertial sensor unit according to an intensity of the V2I signals and the GPS signals; and storing to a database unit the propagation map generated by providing the V2I signals and the position estimated both from the motion measurements of the vehicle and the GPS signals to the propagation map generating unit.

2. The apparatus of claim 1, wherein the V2I signals comprise an ID of a road-side base station, a position of the road-side base station, a current time and signal strength.

3. The apparatus of claim 1, wherein the motion measurements of the vehicle comprise a speed, acceleration and a steering angle of the vehicle.

4. The apparatus of claim 1, wherein the road-side base station is at least one of base stations for DSRC (Dedicated Short Range Communication), UTIS (Urban Traffic Information System), WAVE (Wireless Access in Vehicular Environments), WLAN-Wibro (Wireless LAN-Wireless Broadband Internet), W-CDMA (Wide band Code Division Multiple Access), LTE (Long Term Evolution), or CDMA (Code Division Multiple Access) communication.

5. A method for estimating a position of a vehicle, comprising:
determining, by a control unit, whether it is possible to receive GPS signals from a GPS receiving unit and to estimate the position of the vehicle from the GPS signals;
estimating, by the control unit, the position of the vehicle from the GPS signals according to whether it is possible to estimate the position of the vehicle from the GPS signals, or determining whether it is possible to estimate the position of the vehicle from V2I signals received from a V2I communicating unit in V2I based communication with a road-side base station; and
estimating, by the control unit, the position of the vehicle based on both a propagation map stored on a database unit and the V2I signals according to whether it is possible to estimate the position of the vehicle from the V2I signals, or estimating the position of the vehicle from the motion measurements of the vehicles received from an inertial sensor unit.

6. The method of claim 5, wherein when the control unit estimates the position of the vehicle from the GPS signals, if a precision of the GPS signals is above a preset precision, the control unit estimates the position of the vehicle by compensating the position estimated from the motion measurements of the vehicle received from the inertial sensor unit for the position estimated from the GPS signals.

7. The method of claim 5, wherein when the control unit estimates the position of the vehicle from the V2I signals, if it is decided that the V2I signals are not satisfactorily received, the control unit estimates the position of the vehicle by compensating the position estimated from the motion measurements received from the inertial sensor unit for the position estimated from the V2I signals.

8. The method of claim 5, wherein whether the V2I signals are satisfactorily received is decided by a matching rate and signal strength of the V2I signals.

9. The method of claim 5, wherein the V2I signals comprise an ID of a road-side base station, a position of the road-side base station, a current time and a signal strength.

10. The method claim 5, wherein the motion measurements of the vehicle comprise a speed, acceleration and a steering angle of the vehicle.

11. A method for estimating a position of a vehicle, comprising:
determining, by a control unit, whether it is possible to receive GPS signals from a GPS receiving unit and to estimate the position of a vehicle from the GPS signals:
estimating, by the control unit, the position of the vehicle from the GPS signals according to whether it is possible to estimate the position from the GPS signals, or estimating the position from the motion measurements of the vehicle received from an inertial sensor unit; and
generating, by the control unit, a propagation map by combining V2I signals received from a V2I communicating unit in V2I based communication with a road-side base station on an electronic map stored on a database unit corresponding to the estimated position.

12. The method of claim 11, wherein the V2I signals comprise an ID of a road-side base station, a position of the road-side base station, a current time and a signal strength.

13. The method of claim 11, wherein the motion measurements of the vehicle comprise a speed, acceleration and a steering angle of the vehicle.
